(19) United States
(12) Patent Application Publication
(10) Pub. No.: US 2025/0036395 A1
(43) Pub. Date: Jan. 30, 2025

(54) Orchestrating Parallel Rollouts of Independent Aspects of Production Assets

(71) Applicant: Google LLC, Mountain View, CA (US)

(72) Inventors: Pavel Komkov, Dublin (IE); Zan Smirnov, Toronto (CA); Matthias David Solèr, Zurich (CH); Torsten Marek, Zurich (CH); Niccolo' Cascarano, Zurich (CH)

(21) Appl. No.: 18/226,004

(22) Filed: Jul. 25, 2023

(51) Int. Cl. G06F 8/658

(52) U.S. Cl. CPC G06F 8/658

(57) ABSTRACT

Aspects of the disclosed technology include techniques and mechanisms for orchestrating the parallel rollouts of independent aspects of production assets. One or more APIs may be configured to store, within an aspect store, records indicating one or more updates to be executed, where an update may indicate an asset and aspect therein to be updated. An API may select one or more updates to be deployed and may modify a current state of the selected updates to indicate that an associated update is pending. An API may access the backend development environment associated with the asset and may perform the update indicated in the updates. An API may modify the current state of the executed updates to indicate completion of the updates. The aspect store may modify records stored therein to reflect the most recent values associated with the updated assets and aspects.

### BACKGROUND

A distributed software system may include one or more assets, such as software applications, servers, databases, or configurations and schemas that manage one or more of the applications, servers, or databases. Each asset may be associated with different production and maintenance aspects. An aspect may describe a current state of an asset, such as a current capacity and a current version of an application. After some time, the application may require one or more updates, which an administrator may execute by deploying different updates at scale on the system. Each update may target one or more aspects, such as updating the code that adds a new feature to the application or changes its behavior, modifying the capacity of the application to handle an increase in user demand, modifying dynamic configurations that influence the behavior of the application, or the like. Beyond a particular scale, different aspects may be handled by different processes or teams. For example, the code version of the application or a service may be driven by the application development process, the capacity of the application or the service may be determined by a process that monitors user demand and an amount of available resources, and the dynamic configuration may be modified to react to a change in conditions associated with the application or the service, such as reacting a denial-of-service (DOS) attack.

While different aspects may be handled by different processes or teams, the current deployment process and underlying infrastructure do not provide an abstraction or application programming interface (API) to manage aspects independently. Under the current deployment process, a gradual deployment targeting an update to a specific aspect or to the system might not be implemented within the system unless the deployment addresses each aspect associated with the application or the system. The current deployment execution process and the infrastructure associated with the system may view aspects as a monolith and may require acknowledgement of each aspect so that the system may reach a point of agreement needed to execute the deployment. This may pose a problem for systems that are maintained by disjointed processes or teams that handle different aspects since the teams may need to synchronize respective processes to execute the deployment.

### SUMMARY

Aspects of the disclosed technology include methods, apparatuses, systems, and computer-readable media for orchestrating parallel rollouts of independent aspects of production assets. Aspects of the disclosed technology include techniques and mechanisms for orchestrating the parallel rollouts of independent aspects of production assets. One or more APIs may be configured to store, within an aspect store, records indicating one or more updates to be executed, where an update may indicate an asset and aspect therein to be modified. An update may include a request to modify one or more aspects of one or more assets. An API may select one or more assets to be deployed and may modify a current state of the selected assets to indicate that an associated update is pending. An API may access the backend development environment associated with the asset and may perform the modifications indicated in the updates. An API may modify the current state of the executed updates to indicate completion of the modifications. The aspect store may modify records stored therein to reflect the most recent values associated with the updated assets and aspects.

One aspect of the disclosure provides a system for orchestrating a rollout of independent aspect updates, the system comprising: one or more application programming interfaces (APIs); one or more computing devices configured to communicate with the one or more APIs; and instructions that, when executed, cause the one or more APIs to: receive, from the one or more computing devices, one or more updates to be deployed for execution, wherein an update indicates an asset, an aspect to be updated, and a new value for the aspect; select, from an aspect store storing the received one or more updates to be deployed for execution, one or more updates to be executed; assign a unique change identifier to the one or more updates; update, based on the unique change identifier, a state field associated with the one or more updates; execute, in a system backend and based on the state field, the one or more updates; update, based on the execution, the state field associated with the one or more updates; and modify records within the aspect store based on executing the one or more updates.

According to some examples, the asset corresponds to an entity in production that is associated with an enforceable state.

In the foregoing embodiments, the aspect to be updated corresponds to a single property of the asset.

In the foregoing embodiments, an aspect update indicates the new value of the aspect, wherein the new value of the aspect corresponds to an intended value of the aspect, wherein the intended value of the aspect is different from a baseline intent value of the aspect, and wherein the baseline intent value of the aspect indicates a most recent value or state of the aspect.

According to some examples, the aspect store comprises the records, and wherein the records indicate: a unique asset identifier associated with the asset; an indication of the aspect to be updated, wherein the aspect is associated with the asset; a baseline intent value of the aspect; the state field associated with the one or more updates; and a unique rollout identifier indicating an order in which the one or more updates should be deployed.

In the foregoing embodiment, the state field indicates one of a pending update or a committed update, wherein a pending update state field indicates that the aspect update associated with the one or more updates has not been deployed; and wherein a committed update state field indicates that the aspect update associated with the one or more updates was deployed.

In the foregoing embodiments, the updating, based on the unique change identifier. the state field associated with the one or more updates further causes the one or more APIs to label the one or more updates to be executed as pending.

According to some examples, the executing the one or more updates further causes the one or more APIs to: update a database storing information that describes: a current state of a system infrastructure of the system running the asset and the aspect, and a current production landscape of an updated system infrastructure; and bind an incarnation of the database with the aspect to be updated.

In the foregoing embodiments, the binding the incarnation of the database with the aspect to be updated further causes the one or more APIs to: determine an intended state of the aspect to be reached based on execution of an update; and patch the intended state of the aspect to a baseline intent value of the aspect.

According to some examples, the updating, based on the executing, the state field further causes the one or more APIs to label values associated with aspects indicated in the one or more updates as committed.

According to some examples, modifying the records within the aspect store based on the execution the one or more updates further causes the one or more APIs to: terminate tracking of the unique change identifier associated with the one or more updates; update an aspect value from a baseline intent value to the new value for the aspect; and remove a unique rollout identifier associated with the one or more updates.

Another aspect of the disclosure provides a method of orchestrating a rollout of independent aspect updates, the method comprising: receiving, by one or more application programming interfaces (APIs) and from one or more computing devices, one or more updates to be deployed for execution, wherein an update indicates an asset, an aspect to be updated, and an aspect update; selecting, by the one or more APIs and from an aspect store storing the received one or more updates to be deployed for execution, one or more updates to be executed; assigning, by the one or more APIs, a unique change identifier to the one or more updates; updating, by the one or more APIs and based on the unique change identifier, a state field associated with the one or more updates; executing, by the one or more APIs and in a system backend and based on the state field, the one or more updates; updating, by the one or more APIs and based on the executing, the state field associated with the one or more updates; and modifying, by the one or more APIs, records within the aspect store based on executing the one or more updates.

According to some examples, the aspect store comprises the records, and wherein the records indicate: a unique asset identifier associated with the asset; an indication of the aspect to be updated, wherein the aspect is associated with the asset; a baseline intent value of the aspect; the state field associated with the one or more updates; and a unique rollout identifier indicating an order in which the one or more updates should be deployed.

In the foregoing embodiments, the state field indicates one of a pending update or a committed update, wherein a pending update state field indicates that the aspect update associated with the one or more updates has not been deployed; and wherein a committed update state field indicates that the aspect update associated with the one or more updates was deployed.

In the foregoing embodiments, the updating, based on the unique change identifier, the state field associated with the one or more updates further comprises labeling the one or more updates to be executed as pending.

According to some examples, the executing the one or more updates further comprises: updating, by the one or more APIs, a database storing information that describes: a current state of a system infrastructure of the system running the asset and the aspect, and a current production landscape of an updated system infrastructure; and binding, by the one or more APIs, an incarnation of the database with the aspect to be updated.

In the foregoing embodiments, the binding further comprises: determining, by the one or more APIs, an intended state of the aspect to be reached based on execution of an update; and patching, by the one or more APIs, the intended state of the aspect to a baseline intent value of the aspect.

Another aspect of the disclosure provides a non-transitory computer readable storage medium storing instructions that, when executed by one or more application programming interfaces (APIs) for orchestrating a rollout of independent aspect updates, cause the one or more APIs to: receive, from one or more computing devices, one or more updates to be deployed for execution, wherein an update indicates an asset, an aspect to be updated, and an aspect update; select, from an aspect store storing the received one or more updates to be deployed for execution, one or more updates to be executed; assign a unique change identifier to the one or more updates; update, based on the unique change identifier, a state field associated with the one or more updates; execute, in a system backend and based on the state field, the one or more updates; update, based on the executing, the state field associated with the one or more updates; and modify records within the aspect store based on executing the one or more updates.

According to some examples, the executing the one or more updates further causes the one or more APIs to: update a database storing information that describes: a current state of a system infrastructure of the system running the asset and the aspect, and a current production landscape of an updated system infrastructure; and bind an incarnation of the database with the aspect to be updated.

In the foregoing embodiments, the binding the incarnation of the database with the aspect to be updated further causes the one or more APIs to: determine an intended state of the aspect to be reached based on execution of an update; and patch the intended state of the aspect to a baseline intent value of the aspect.

### BRIEF DESCRIPTION OF THE DRAWINGS

FIG. 1 illustrates an example block diagram of a deployment orchestration system for orchestrating the parallel rollouts of independent aspects of production assets, in accordance with aspects of the disclosure.

FIG. 2 illustrates a flow diagram for an example method of orchestrating the parallel rollout of independent aspects of production assets, in accordance with aspects of the disclosure.

FIG. 3 illustrates an example aspect store data schema that may be used for orchestrating the parallel rollout of independent aspects of production assets, in accordance with aspects of the disclosure.

FIG. 4 illustrates an example process or method of orchestrating the parallel rollouts of independent aspects of production assets, in accordance with aspects of the disclosure.

FIG. 5 illustrates the components of an update deployment orchestration environment and a current state of an example aspect store for orchestrating the parallel rollouts of independent aspects of production assets, in accordance with aspects of the disclosure.

FIG. 6 illustrates an example API component selecting an asset and an aspect to be updated and announcing the selected update to orchestrate the parallel rollouts of independent aspects of production assets, in accordance with aspects of the disclosure.

FIG. 7 illustrates an example API component pushing a selected update for deployment to orchestrate the parallel rollouts of independent aspects of production assets, in accordance with aspects of the disclosure.

FIG. 8 illustrates binding updates incarnations to aspects to be modified to orchestrate the parallel rollouts of independent aspects of production assets, in accordance with aspects of the disclosure.

FIG. 9 illustrates an example implementation of updating an aspect backend to orchestrate the parallel rollouts of independent aspects of production assets, in accordance with aspects of the disclosure.

FIG. 10 illustrates an example aspect store updated to reflect a successful update deployment, in accordance with aspects of the disclosure.

FIG. 11 illustrates a block diagram of an example computing environment for orchestrating the parallel rollouts of independent aspects of production assets, in accordance with aspects of the disclosure.

### DETAILED DESCRIPTION

This technology relates to orchestrating parallel rollout of independent aspects of production assets. An asset may refer to an entity in production that has an enforceable state, such as software configured to manage production machines. An aspect may refer to a state or property of a single asset, a feature of the asset, or a particular functionality of the asset, such as whether software was backed up at a particular time, a version of the software or the backup, a capacity of the software to handle an increase in user demand, or the like. A rollout may be a process in which a change to one or more assets is decomposed into smaller changes associated with different aspects of the assets, wherein the smaller changes to the different aspects may be deployed at different times. The rollout may correspond to parallel update deployments associated with the asset(s) within a distributed computing system, where each deployment may target a different aspect of the asset.

Therefore, introduced herein is an aspect aware deployment method for orchestrating the parallel rollouts of updates of independent aspects of production assets. The aspect aware deployment method may separate a monolith deployment process into independent processes such that processes that correspond to distinct aspects may execute independently and might not interfere with the execution of other deployments acting on the same asset. The aspect aware deployment method may provide for the concurrent update of different aspects associated with a common asset, where the updates may progress at different speeds. Further, the aspect aware deployment method may provide for the dissolution or rollback of particular aspects without disrupting other aspects associated with the same asset. The rollback may indicate an update to be canceled or reversed, an asset to be removed from the system, an aspect to removed from the asset, or the like. In some instances, the aspect aware deployment method may provide for selective version overrides where a specific asset version may be deployed to an asset fleet and may persist until removed through a subsequent deployment. In some instances, the aspect aware deployment process may define rollbacks by labeling particular deployments such that the particular deployments are not implemented or so that corrective may be taken if the particular deployments were previously implemented.

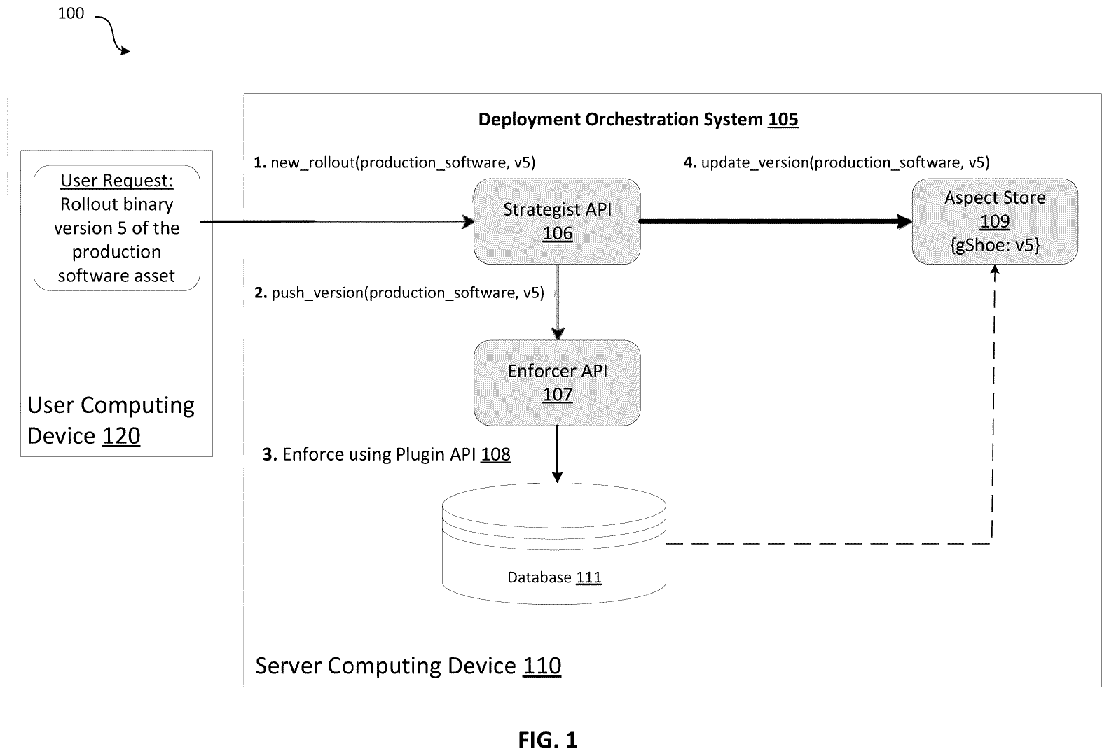

FIG. 1 illustrates an example block diagram of a deployment orchestration system for orchestrating the parallel rollout of independent aspects of production assets, in accordance with aspects of the disclosure. The computing environment illustrated in FIG. 1 may correspond to deployment orchestration system 105, which may be used to execute the method described herein. Deployment orchestration system 105 may be associated with or may exist within a server computing device, such as server computing device 110. Further, deployment orchestration system 105 may receive user requests or user input from a user computing device, such as user computing device 120.

Deployment orchestration system 105 may include a plurality of application programming interfaces (APIs), including strategist API 106, enforcer API 107, and plugin API 108. In some instances, the APIs within deployment orchestration system 105 may be collapsed into a single API. Multiple APIs are described herein by way of example, not limitation. The APIs may be configured to communicate with aspect store 109 and database 111 to orchestrate the parallel rollout of independent aspects of production assets. In some instances, database 111 may house a production model that may be used to perform the method described herein. For example, the production model within database 111 may correspond to a declarative production model. Database 111 may store additional or alternative production models that may be used to execute the described method.

Deployment orchestration system 105 and the components therein may be used to select and execute a rollout. Deployment orchestration system 105 may exist within a computing device and the computing device may receive a user request to execute a rollout. For example, deployment orchestration system 105 may be associated with a server computing device, such as server computing device 110 discussed below, and may receive, from server computing device 110. a notification that a user request has been received, where the user request is to rollout version 5 of a production software asset. In some instances, strategist API 106 may be configured to receive one or more requests from a user computing device, such as user computing device 120 discussed below, and may be configured to select at least one request to be implemented. In some instances, strategist API 106 may be configured to receive, from user computing device 120, one or more updates to be deployed, where the one or more updates may indicate an asset to be updated as well as a particular aspect of the asset to be updated.

Strategist API 106 may push the selected update to the other components of deployment orchestration system 105 to inform the other components of the one or more selected updates to be deployed. For example, strategist API 106 may transmit a notification to enforcer API 107 to push_version(production_software, v5). Enforcer API 107 may assign a unique change identifier to the one or more selected updates to be deployed and may transmit the unique change identifier to plugin API 108. Enforcer API 107 may instruct plugin API 108 to enforce the update. Plugin API 108 may query aspect store 109 using the unique change identifier received from enforcer API 107. Based on the querying, plugin API 108 may identify the one or more selected updates to be deployed. Plugin API 108 may access a backend development environment responsible for running the asset and corresponding aspect. Plugin API 108 may perform the aspect updates indicated in the one or more selected updates and may update database 111 using the executed updates.

In some instances, plugin API 108 may notify aspect store 109 upon completion of the updates indicated in the one or more executed updates, as illustrated by the dashed lined from database 111 to aspect store 109 in FIG. 1. Aspect store 109 may update records stored therein to reflect updated values associated with the updated asset and corresponding updated aspects.

In some instances, plugin API 108 may notify strategist API 106 upon completion of the executed update. Strategist API 106 may notify aspect store 109 of the executed update and may instruct aspect store 109 to update the records stored therein that pertain to the aspect that was updated. For example, strategist API 106 may inform aspect store 109 that the production software aspect was updated to version 5 and may instruct aspect store 109 to query the records therein for records pertaining to the production software aspect and to update the records accordingly.

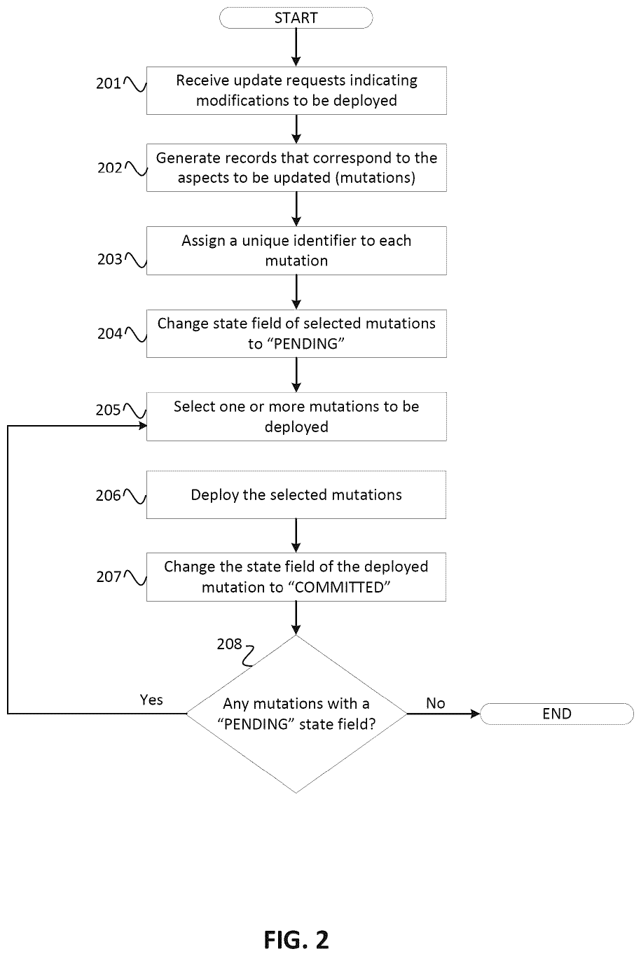

FIG. 2 illustrates a flow diagram for an example method of orchestrating the parallel rollout of independent aspects of production assets, in accordance with aspects of the disclosure. The operations described herein are presented in the current order by way of example, and the order is not meant to be limiting. Moreover, operations may be omitted from or added to the example method. The method and techniques described herein may be performed by one or more computing devices associated with maintaining the assets currently in production. In some instances, the methods and techniques described herein may be performed by computing devices associated with teams or processes that may be responsible for controlling or supporting the assets. In particular, the teams or processes responsible for the maintenance of particular aspects may execute the method described herein to independently manage and update a particular aspect without generating a request to update the entirety of an asset associated with the particular aspect.

The method described herein may be performed by devices and components in deployment orchestration system 105, server computing device 110, user computing device 120, and data center 140. In some examples, the method described herein may be performed with additional or alternative computing devices and components therein.

At block 201, deployment orchestration system 105 may receive, from user computing device 120, one or more update requests indicating modifications to be deployed. An update may indicate an asset to be updated and a specific aspect within the asset to which the update may pertain. The combination of the asset and the update to the asset may be referred to herein as an update. For example, where an asset is an orchestration system for automated software deployment, aspect store 109 may monitor the corresponding aspects, such as a version of an image and a number of image replicas. As another example, where an asset is a database management system, aspect store 109 may monitor the corresponding aspects, such as an access control configuration, a database schema, and disk space allocation.

At block 202, aspect store 109 may generate records that describe each update received from user computing device 120. In particular, the records may correspond to the update of the aspects to updated within each asset identified by user computing device 120. In some instances, the records may correspond to mutations, where a mutation may refer to the updates associated with each aspect. Each asset and aspect indicated in the one or more received updates may be recorded in asset store 109. Aspect store 109 may monitor one or more aspects associated with one or more assets and may function as a blueprint for updates to be deployed.

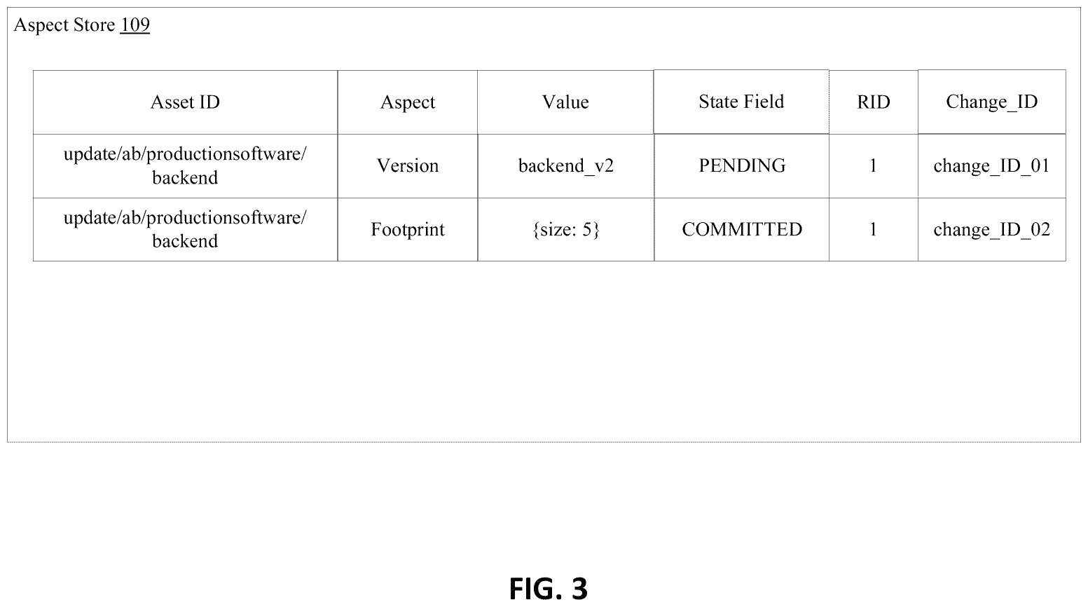

FIG. 3 illustrates an example aspect store that may be used for orchestrating the parallel rollout of independent aspects of production assets, in accordance with aspects of the disclosure. As illustrated in FIG. 3, aspect store 109 introduced in connection with FIG. 1, may record assets associated with the one or more received updates. Each asset may correspond to a unique asset identifier, such as an Asset ID. The unique identifier of each asset, the aspect name, and a unique rollout identifier, such as RID, may function as a primary key within aspect store 109, where the primary key may be used to join the asset and aspect with other data in aspect store 109.

Asset store 109 may indicate one or more aspects associated with each asset listed in asset store 109. For example, aspects associated with assets may indicate a version of the asset to be updated or a size capacity of an asset footprint to be increased.

Asset store 109 may also record a current state of each aspect associated with an asset, record ongoing aspect updates or scheduled aspect updates, monitor deployments that may affect each aspect or asset, and continuously update the records based on the monitoring. Aspect store 109 may store values for updates associated with aspects currently in production. Each update may be accompanied by a state field that indicates whether the update has been deployed, such as “COMMITTED,” or has not yet been deployed, such as “PENDING.” In some instances, a state field indicating a “PENDING” update may indicate that an aspect update associated with an update might not have been deployed. Further, in some instances, a state field indicating a “COMMITTED” update may indicate that an aspect modification associated with an update has been deployed. The “COMMITTED” state field may indicate a baseline intent value of the corresponding aspect that is currently deployed in production, whereas the “PENDING” state field may indicate a modification to the baseline intent value of the corresponding aspect. The baseline intent value may indicate the most current value or state of the aspect. Deploying an update may include changing the baseline intent value to an intended value, where the intended value corresponds to a new value of the aspect to be updated.

For example, as illustrated in FIG. 3, the baseline intent value of the “PENDING” update indicates that the update running backend_v2 may require an updated backend version, whereas the baseline intent value of the “COMMITTED” update indicates that a current size capacity of an asset footprint is 5 units and that there are no updates associated with the current size of the asset footprint.

In some instances, a value associated with an aspect may indicate the intended update to be deployed on the aspect. For example, where an update to an aspect is a version update/modification, then the value may indicate the intended version to be run on the aspect.

Further, in some instances, aspect store 109 may indicate a rollout value, which may denoted by the unique rollout identifier, such as RID. For records with “PENDING” status, the unique rollout identifier may indicate an order in which updates should be deployed. In some instances the “PENDING” status indicator may serve as an identifier to store a history of mutations and the order that they were applied.

In some instances, aspect store 109 may store an identifier for an update that is currently in progress, indicated by a unique identifier such as change_ID. For example, the aspect store may store the latest “COMMITTED” value for each record as well as the latest “PENDING” value with a unique change identifier, such as change_id. In some instances, the unique change identifier may be used to query aspect store 109. Querying aspect store 109 with the unique change identifier may return records associated with the unique change identifier, both “PENDING” and “COMMITTED.” However, if the unique change identifier does not match any of the records within aspect store 109, then the most recent “COMMITTED” values may be returned. In some instances, aspect store 109 may be queried without use of the unique change identifier, where records with the latest “COMMITTED” value may be returned.

Returning to FIG. 2, deployment orchestration system 105 may use the APIs therein, plugin API 108, and aspect store 109 to execute the aspect aware deployment method.

At block 203, enforcer API 107 may assign a unique identifier to the one or more updates selected by strategist API 106. In some instances, enforcer API 207 may assign a unique identifier to each mutation. To do so, enforcer API 107 may receive notification of the one or more updates to be deployed. In some instances, enforcer API 107 may receive the notification based on the announcement by strategist API 106. In some instances, the unique identifier may be the unique change identifier used to indicate changes to the state fields, such as change_id. Each update selected by strategist API 106 may be assigned the same change_id, thereby grouping together all of the updates selected by strategist API 106 at one time.

At block 204, for each update or mutation that receives a change_id from enforcer API 107, aspect store 109 may change a state field associated with the update or mutation to “PENDING.” Enforcer API 107 may transmit the change_id to plugin API 108, such as a Borg plugin, to execute the update.

At block 205, strategist API 106 may select, from asset store 109, one or more updates or mutations to be deployed. Strategist API 106 may be configured to operate as a scheduling system. Strategist API 106 may be the only component or API used to drive rollouts. thereby making strategist API 106 the only API that may be able to modify production and assets associated with production.

Strategist API 106 may select, from aspect store 109, an asset and may announce, to deployment orchestration system 105, an update or mutation to the selected asset. In some instances, strategist API 106 may select the update or mutation based on the unique rollout identifiers listed in aspect store 109. For example, if an asset is associated with a unique rollout identifier that suggests a corresponding aspect should be updated in a first round rollout, then strategist API 106 may select that update to be deployed.

At block 206, plugin API 108 may deploy the one or more updates or mutations selected by strategist API 106, thereby executing the aspect update indicated in each update. To do so, plugin API may receive the change_id from enforcer API 107 and may use the change_id to identify the one or more updates within aspect store 109 to be deployed. Plugin API 108 may be configured to read data from and write data to a database or data source, such as database 111. within deployment orchestration system 105. Plugin API 108 may perform the one or more updates, thereby implementing the update associated with the aspect indicated in the update. Plugin API 108 may update database 111 such that the information within database 111 reflects the most recent update made on the aspect and corresponding asset in production. In some instances, updating database 111 may include updating a system infrastructure of the system running the asset. Further, updating database 111 may include describing a current production landscape from the point of view of the recently updated system infrastructure.

Plugin API 108 may be configured to execute service configurations on the assets listed in the aspect store. In particular, plugin API 108 may be configured to access a development backend associated with the asset and to perform necessary updates on the backend.

As a database or data source, the production specification may be configured to store information that describes a current state of the system infrastructure of the system running the asset and the most recent updates to the system infrastructure. In some instances, the production specification may maintain a history of system infrastructure updates and a history of system configurations.

To execute the update or mutation, plugin API 108 may bind an incarnation and the aspect indicated in the update. An incarnation may indicate a version of a database, such as a new version of a database that may be generated based on one or more changes to the data stored in the database, the data for assets and aspects associated with the database, or the like. Binding the incarnation of database 111 and the aspect may include updating database 111 to reflect the changes to the asset and the aspect, and to reflect the most current state of the asset. In some instances, the binding may include determining an intended state of the aspect to be reached upon execution of the update and patching the intended state with the current baseline intent value of the aspect, where the baseline intent value may be the current “COMMITTED” value of the aspect. Plugin API 108 may notify the aspect store when the execution of the update is complete and may initiate a feedback loop.

At step 207, aspect store 109 may update the records stored therein. Based on receiving the notification indicating completion of the one or more updates or mutations, aspect store 109 may change the state field associated with the update or mutation from “PENDING” to “COMMITTED.” Further, based on receiving the notification indicating completion of the one or more updates or mutations, plugin API 108 may modify records associated with the one or more updates or mutations such that aspect store 109 no longer tracks the change_ID associated with the one or more updates or mutations since the one or more updates or mutations were executed and marked as “COMMITTED.”

Aspect store 109 may also update the aspect values associated with the one or more updates or mutations. For example, where a value of an aspect changed after execution of an update or mutation, aspect store 109 may reflect the current value of the aspect where the current value of the aspect may correspond to an updated aspect value. Therefore, computing devices that access aspect store 109 may be aware of current “COMMITTED” values associated with the aspects listed in aspect store 109. In some instances, aspect store 109 may terminate tracking of, or remove from the records therein, the unique rollout identifier associated with the one or more executed updates or mutations.

At block 208, strategist API 106 may analyze aspect store 109 and the records therein to determine whether aspect store 109 lists updates or mutations awaiting deployment. To do so, strategist API 106 may determine whether any updates or mutations listed in aspect store 109 are associated with a “PENDING” state field. Further, in some instances, strategist API 106 may determine whether updates listed within aspect store 109 are associated with a unique rollout identifier since the unique rollout identifier may indicate an order in which the corresponding update should be deployed. Based on determining that the updates listed in aspect store 109 are not awaiting deployment, the process described herein may terminate.

Alternatively, based on determining at least one update or mutation listed in aspect store 109 is associated with a “PENDING” state field or a unique rollout identifier, strategist API 106 may return to block 205 and may repeat the process described herein. The process described herein may be repeated as needed to deploy one or more updates or mutations to update one or more aspects associated with one or more assets. In some instances, and as described above, updates may be deployed independently and individually by creating update deployment pipeline to consecutively deploy updates associated with a common aspect. However, in some instances, deployment orchestration system 105 may be tasked with simultaneous, or parallel, update deployments. To perform parallel update deployments, more than one update deployment pipeline may be created to handle each update deployment.

For example, in instances where an asset requires a software update as well as a capacity update, a first update deployment pipeline may be initiated to handle the software update while a second update deployment pipeline may be initiated to handle the capacity update. The process described herein may be implemented in both pipelines to execute both updates. In some instances, the update deployment in one pipeline may occur faster than the update deployment in another pipeline. Since the deployments are performed as independent processes, the speed of the faster deployment might not affect the speed of the other.

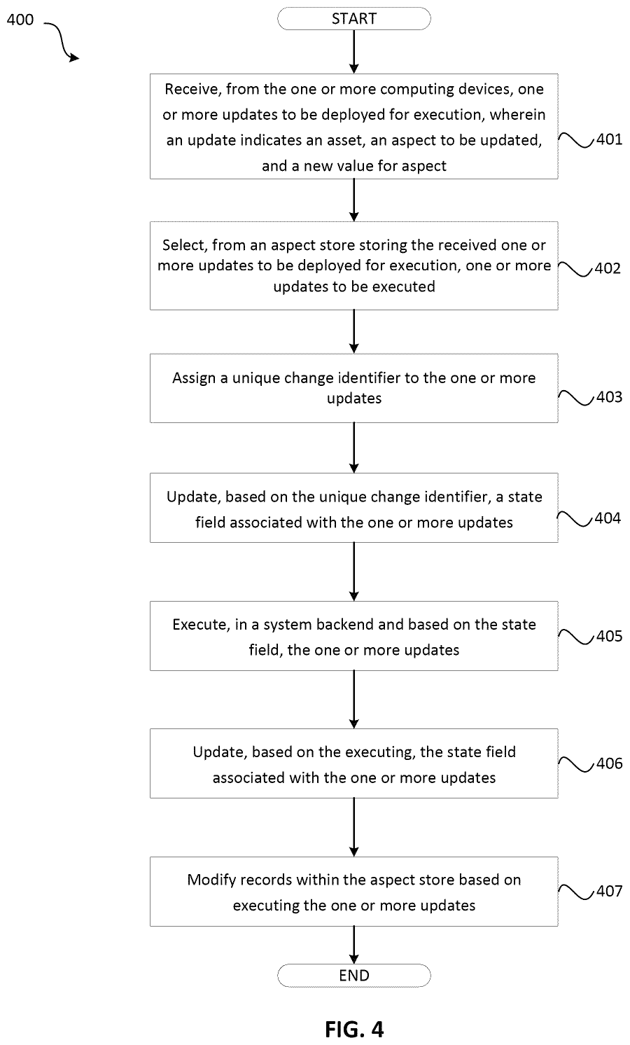

FIG. 4 illustrates an example process or method of orchestrating the parallel rollouts of independent aspects of production assets, in accordance with aspects of the disclosure. The operations described in example method 400 are presented in the current order by way of example. and the order is not meant to be limiting. Moreover, operations may be omitted from or added to the example method. The method described herein may be performed by devices and components illustrated in example environment 100, such as deployment orchestration system 105 and the components therein. In some examples, the method described herein may be performed with additional or alternative computing devices and components therein.

At block 401, deployment orchestration system 105 may receive, from user computing device 120, one or more updates to be deployed where an update may indicate an asset to be updated and a new value for the aspect within the asset to be updated.

At block 402, strategist API 106 may select, from asset store 109, one or more updates to be deployed. Strategist API 106 may select, from aspect store 109, an asset and may announce, to deployment orchestration system 105, an update to the selected asset to be executed.

At block 403, enforcer API 107 may assign a unique change identifier to the one or more updates selected by strategist API 106 based on receiving a notification from strategist API 106 indicating the one or more updates to be deployed. In some instances, the unique identifier may be the unique change identifier used to indicate changes to the state fields, such as change_id.

At block 404, aspect store 109 may change a state field associated with the one or more updates to “PENDING.”

At block 405, plugin API 108 may deploy the one or more updates selected by strategist API 106, thereby executing the aspect update indicated in each update. To do so, plugin API 108 may bind an incarnation and the aspect indicated in an update of the one or more updates. An incarnation may indicate a version of a database, such as a new version of a database that may be generated based on one or more changes to the data stored in the database, the data for assets and aspects associated with the database, or the like. Binding the incarnation of database 111 and the aspect may include updating database 111 to reflect the changes to the asset and the aspect, and to reflect the most current state of the asset. Plugin API 108 may alert aspect store 109 of the completion of the aspect updates indicated in the one or more updates.

At block 406, based on receiving a notification from plugin API 108 indicating completion of the one or more updates, aspect store 109 may change the state field associated with the one or more updates from “PENDING” to “COMMITTED.”

At block 407, aspect store 109 may modify records therein based on the completed execution of the one or more updates. In particular, aspect store 109 may update the aspect values associated with the one or more updates. In some instances, aspect store 109 may terminate tracking of, or remove from the records therein, the unique rollout identifier associated with the one or more executed updates.

In some implementations, strategist API 106 may detect more than one update directed to updating the same aspect. In such instances, aspect store 109 may be configured to function as a semaphore or mutex to prevent further updates to an aspect that may be currently undergoing a pending update. Additionally, in such instances, an additional state field of “IN PROGRESS” may be introduced. The implementation of the additional state field may prevent strategist API 106 from selecting for deployment one or more updates directed to updating the same aspect.

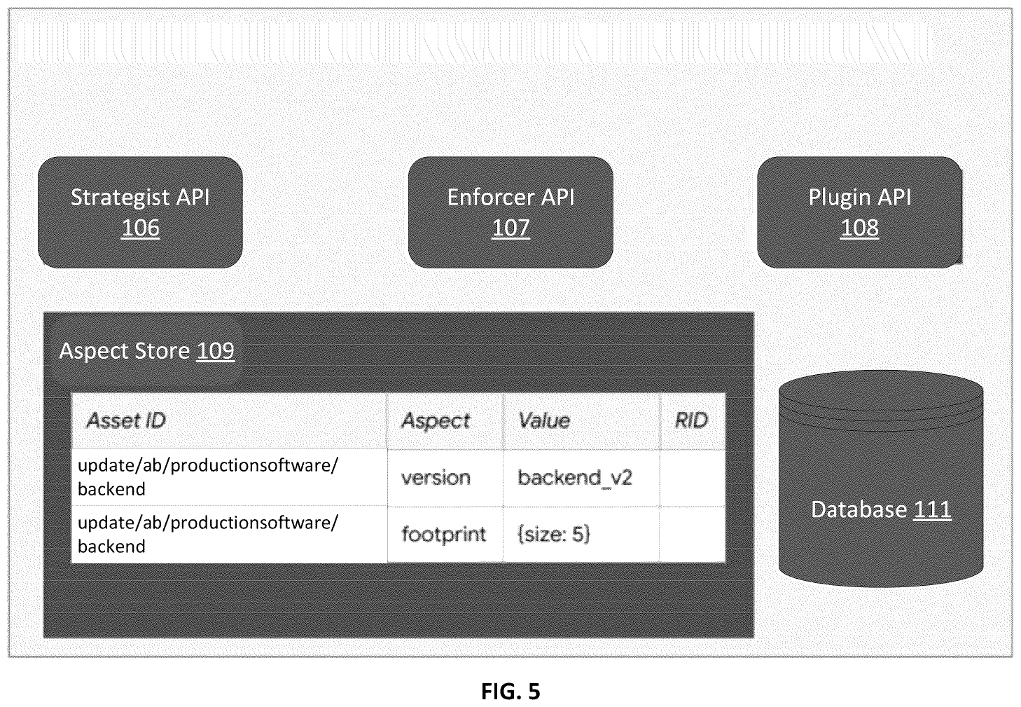

FIGS. 5-10 illustrate an example implementation of orchestrating the parallel rollouts of independent aspects of production assets, in accordance with aspects of the disclosure. FIG. 5 illustrates the components of deployment orchestration system 105 as well as a current state of aspect store 109. As illustrated in FIG. 5 and according to aspect store 109, the aspect version of the production software asset is currently running version 2 on the backend.

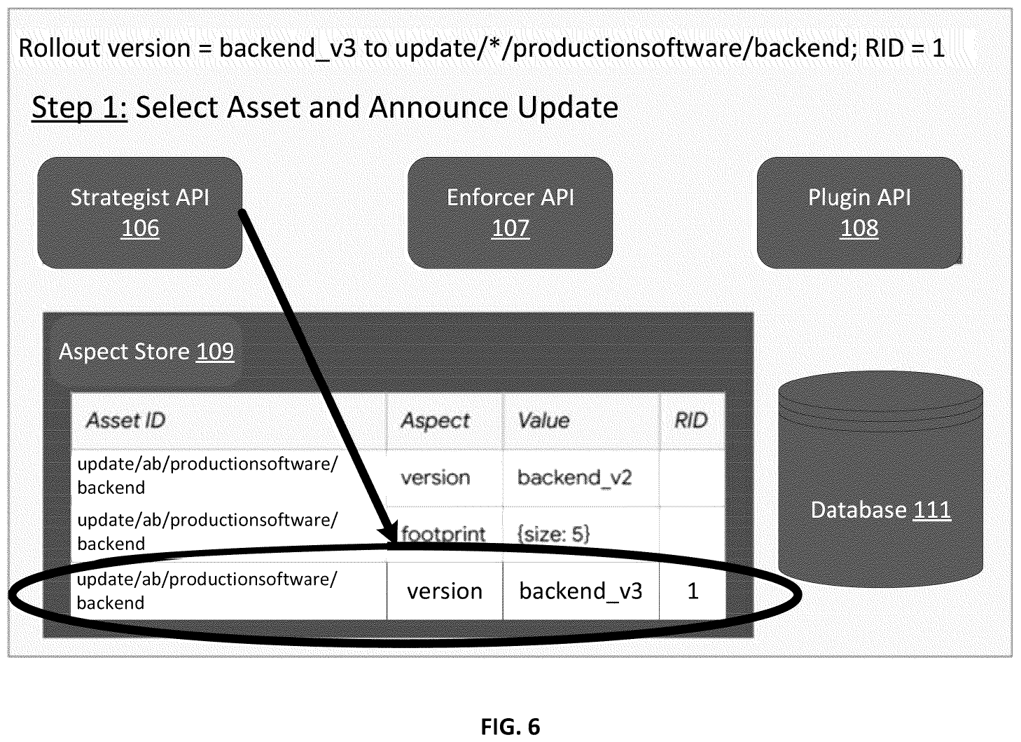

FIG. 6 illustrates selecting an asset to update and announcing the selected update for orchestrating the parallel rollouts of independent aspects of production assets, in accordance with aspects of the disclosure. As illustrated at the top of FIG. 6, the rollout in this example pertains to a version upgrade of the production software asset, namely upgrading the backend version of the production software asset from version 2 to version 3. In accordance with the method described herein, strategist API 106 may query aspect store 109 to select one or more updates to be deployed. Strategist API 106 may consider a unique rollout identifier (RID) associated with the updates and records within aspect store 109. In some instances, strategist API 106 may select the one or more updates to be deployed based on the RID associated with the one or more updates. For example, strategist API 106 may select the one or more updates with the lowest RID and may progress sequentially through the remaining updates based on the increasing value of the RID associated with the remaining updates. As illustrated in FIG. 6 strategist API 106 may identify an update within aspect store 109 with the lowest RID and may elect that update for deployment. For example, the update associated with the lowest RID may correspond to the user request to update the backend version of the production software asset to version 3, as illustrated in the ellipse. Strategist API 106 may select one or more updates for deployment and announce the selected one or more updates to the remaining components within deployment orchestration system 105.

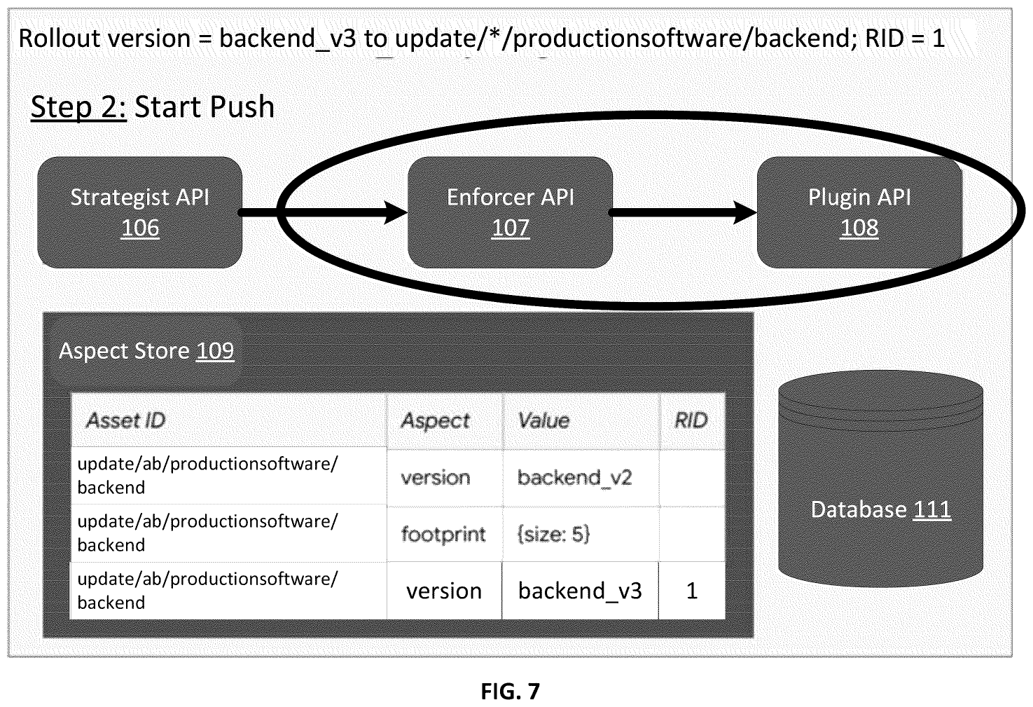

FIG. 7 illustrates pushing the selected update for deployment to orchestrate the parallel rollouts of independent aspects of production assets, in accordance with aspects of the disclosure. As illustrated in FIG. 7, enforcer API 107 and plugin API 108 may execute the one or more updates selected by strategist API 106, as illustrated by the ellipse. In some instances, enforcer API 107 and plugin API 108 may execute the one or more updates based on receiving the announcement from strategist API 106.

Enforcer API 107 may assign a unique identifier to the one or more updates selected by strategist API 106. In some instances, the unique identifier may be the unique change identifier used to indicate changes to the state fields, such as change_id. Each update selected by strategist API 106 may be assigned the same change_id, thereby grouping together all of the updates selected by strategist API 106 at one time. For each update that receives a change_id from enforcer API 107, aspect store 109 may change a state field associated with the update to “PENDING.” Enforcer API 107 may transmit the change_id to plugin API 108 to execute the update.

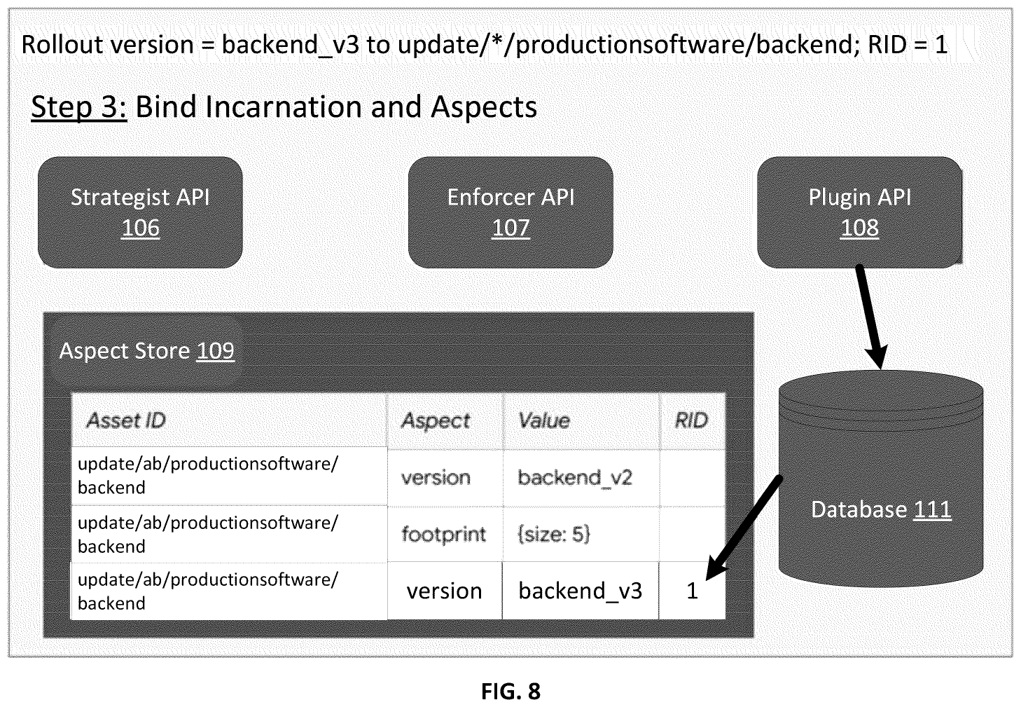

FIG. 8 illustrates binding update deployment incarnations to aspects to be updated to orchestrate the parallel rollouts of independent aspects of production assets, in accordance with aspects of the disclosure. Plugin API 108 may bind an incarnation and the aspect indicated in the update. Binding the incarnation of database 111 and the aspect may include updating database 111 to reflect the changes to the asset and the aspect, and to reflect the most current state of the asset. In some instances, the binding may include determining an intended state of the aspect to be reached upon execution of the update and patching the intended state with a current baseline intent value of the aspect, where the baseline intent value may be the current “COMMITTED” value of the aspect. For example, the current “COMMITTED” value of the version of the production software asset may be version 2 and the intended state of the version of the production software asset may be version 3. Binding the intended state to the baseline invent value may generate a version history of the asset, which may be stored in aspect store 109. Further, the binding may indicate, for each updated aspect of each asset, the current state of the aspect or, in other words, the current value of the updated aspect.

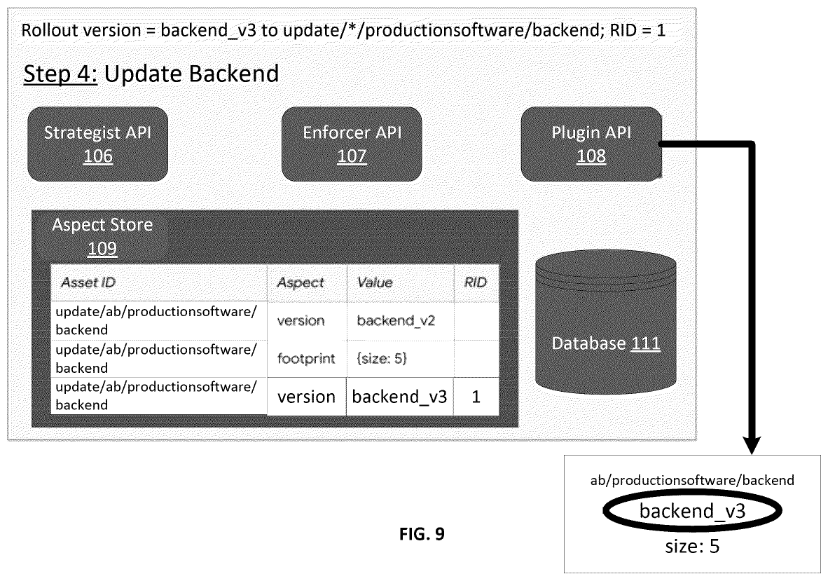

FIG. 9 illustrates an example implementation of updating an aspect backend to orchestrate the parallel rollouts of independent aspects of production assets, in accordance with aspects of the disclosure. Plugin API 108 may access the development backend associated with the asset. For example, plugin API 108 may access the development backend or coding environment associated with the production software asset. Within the development backend. plugin API 108 may locate any description of the aspect associated with the update. Plugin API 108 may update each mention of the aspect within the development backend such that all mentions of the aspect point to the intended state of the aspect as opposed to the baseline intent value of the aspect. For example, as illustrated in FIG. 9, plugin API 108 may change the version of the production software asset to version 3 in the development backend.

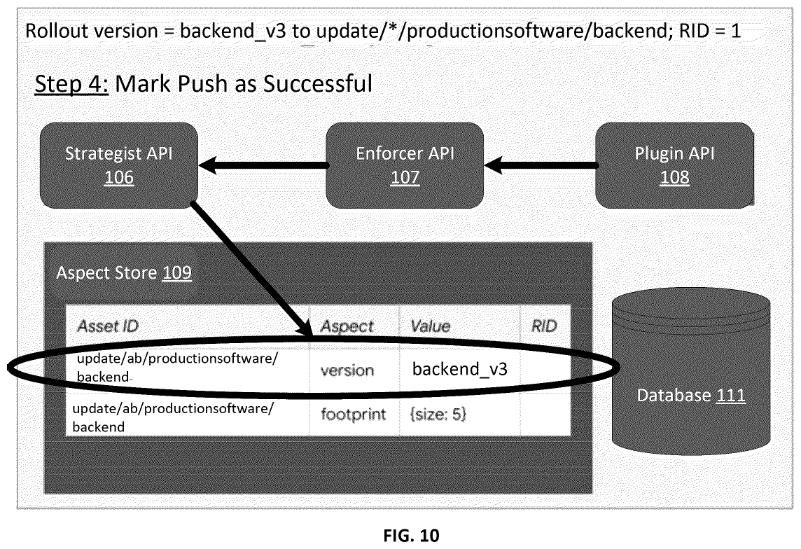

FIG. 10 illustrates an example aspect store updated to reflect a successful update deployment, in accordance with aspects of the disclosure. Plugin API 108 may alert strategist API 106 of the completion of the one or more executed updates. In some instances, plugin API 108 may transmit the alert to strategist API 106 via enforcer API 107. Strategist API 106 may query aspect store 109 and may parse the current baseline intent value of the update aspect. If the baseline intent value of the aspect matches the value that was indicated in the user request, strategist API 106 may mark the update push as successful. For example, strategist API 106 may query aspect store 109 and may determine that the current baseline intent value of the production software asset indicates a backend version of version 3. Strategist API 106 may determine that the current baseline intent value of the updated aspect matches the update indicated in the user request, and strategist API 106 may mark the update push as a success.

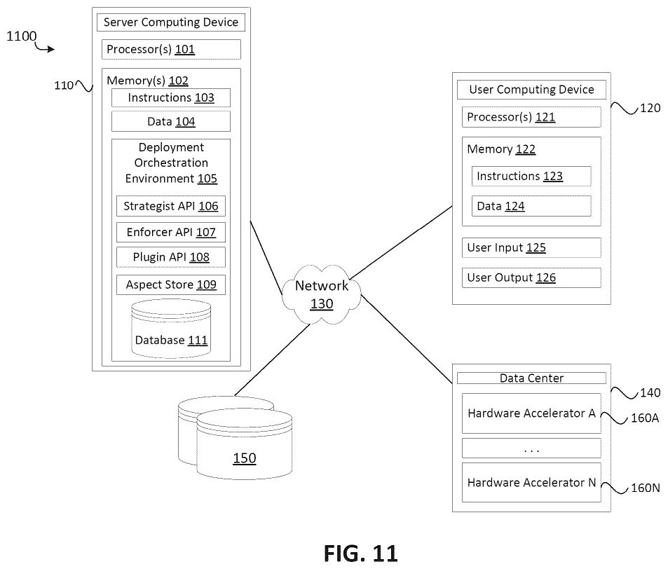

FIG. 11 illustrates a block diagram of an example computing environment for orchestrating the parallel rollouts of independent aspects of production assets, in accordance with aspects of the disclosure. The parallel rollouts of independent aspects of production assets may be implemented using one or more devices having one or more processors in one or more locations. such as server computing device 110 and user computing device 120 in computing environment 1100. Server computing device 110 and user computing device 120 may be communicatively coupled to one or more storage devices over a network. The storage devices may be a combination of volatile and non-volatile memory and may be at the same or different physical locations than the computing devices. For example, the storage devices may include any type of non-transitory computer readable medium capable of storing information, such as a hard-drive, solid state drive, tape drive, optical storage, memory card, ROM, RAM, DVD, CD-ROM, write-capable, and read-only memories. In some instances, database 150 may store data transmitted across network 130 and between server computing device 110, user computing device 120, and data center 140).

Server computing device 110 may include one or more processors and memory. such as processor(s) 101 and memory(s) 102, referred to herein as processor 101 and memory 102. respectively. Memory 102 may include instructions 103, data 104, and deployment orchestration system 105. Deployment orchestration system 105 may include a plurality of application programming interfaces (APIs), including strategist API 106, enforcer API 107, and plugin API 108.

Memory 102 may store information accessible by processor 101, including instructions 103 that may be executed by processor 101. Memory 102 may also include data 104 that may be retrieved, manipulated, or stored by the processor 101. Memory 102 may be a type of non-transitory computer readable medium capable of storing information accessible by processor 101, such as volatile and non-volatile memory. Processor 101 may include one or more central processing units (CPUs), graphic processing units (GPUs), field-programmable gate arrays (FPGAs), and/or application-specific integrated circuits (ASICs).

Instructions 103 may include one or more instructions that, when executed by processor 101, cause processor 101 to perform actions defined by instructions 103. Instructions 103 may be stored in object code format for direct processing by processor 101, or in other formats including interpretable scripts or collections of independent source code modules that are interpreted on demand or compiled in advance. Instructions 103 may include instructions for orchestrating the parallel rollout of independent aspects of production assets. The described parallel rollout may be executed using processor 101 and/or using other processors remotely located from server computing device 110.

Data 104 may be retrieved, stored, or modified by processor 101 in accordance with the instructions. Data 104 may be stored in computer registers, in a relational or non-relational database as a table having a plurality of different fields and records, or as JSON, YAML, proto, or XML documents. Data 104 may also be formatted in a computer-readable format such as, but not limited to, binary values, ASCII, or Unicode. Moreover, data 104 may include information sufficient to identify relevant information, such as numbers, descriptive text, proprietary codes, pointers, references to data stored in other memories, including other network locations, or information that is used by a function to calculate relevant data.

Server computing device 110 may be configured to receive, from user computing device 120, one or more requests to update one or more assets and one or more aspects associated with the one or more assets. Upon receipt of the one or more requests, server computing device 110 may process the request using deployment orchestration system 105 and the components therein. In particular, strategist API 106 may be configured to receive the one or more requests from user computing device 120 and may be configured to select at least one request to be implemented. In some instances, strategist API 106 may be configured to receive, from user computing device 120, one or more updates to be deployed, where the one or more updates may indicate an asset to be updated as well as a particular aspect of the asset to be updated.

Strategist API 106 may inform the remaining components of deployment orchestration system 105 of the one or more selected updates to be deployed. Enforcer API 107 may assign a unique change identifier to the one or more selected updates to be deployed and may transmit the unique change identifier to plugin API 108. Plugin API 108 may query aspect store 109 using the unique change identifier received from enforcer API 107. Based on the querying, plugin API 108 may identify the one or more selected updates to be deployed. Plugin API 108 may access a backend development environment responsible for running the asset and corresponding aspect. Plugin API 108 may perform the aspect updates indicated in the one or more selected updates and may update database 111 using the executed updates.

Plugin API 108 may notify aspect store 109 upon completion of the updates indicated in the one or more executed updates. Aspect store 109 may update records stored therein to reflect updated values associated with the updated asset and corresponding updated aspects.

In some instances, deployment orchestration system 105 may correspond to a single update deployment pipeline. The single update deployment pipeline may be used to update a particular aspect. Additional update deployment pipelines may be initiated to execute updates on different aspects. The one or more update deployment pipelines may operate simultaneously to orchestrate the parallel rollout of independent aspects of production assets. As such, individual aspects of an asset may be updated in parallel without a single update request having to address each aspect of the asset.

User computing device 120 may be configured similarly to server computing device 110, with one or more processors 121, memory 122, instructions 123, and data 124. User computing device 120 may also include user input 125 and user output 126. User input 125 may include any appropriate mechanism or technique for generating a user input, such as keyboard, mouse, mechanical actuators, soft actuators, touchscreens, microphones, and sensors. User output 126 may additionally include one or more speakers, transducers or other audio outputs, a haptic interface or other tactile feedback that provides non-visual and non-audible information to the platform user of user computing device 120.

User computing device 120 may be configured to transmit data to server computing device 110, and server computing device 110 can be configured to display at least a portion of the received data on a display.

User computing device 120 may be configured to transmit, to server computing device 110, one or more requests to update one or more assets and one or more aspects associated with the one or more assets. Each request transmitted to server computing device 110 may correspond to an update to be deployed by deployment orchestration system 105. Server computing device 110 may receive, from server computing device 110, a notification indicating execution and implementation of the update indicated the one or more transmitted requests. In particular, user computing device 120 may receive the notification from aspect store 109 running on server computing device 110. The received notification may be displayed on user computing device 120.

As described above, different aspects of an asset may be maintained by different teams or processes. Each team or process that is responsible for a distinct aspect may correspond to a different user computing device. While a single user computing device is illustrated in FIG. 11, computing environment 1100 may include more than one user computing device. For example, for each aspect controlled by a team, the team may be associated with a dedicated user computing device. The team may use the dedicated user computing device to transmit, to server computing device 110, a request to update, or perform another function on, the aspect controlled by the team.

Although FIG. 11 illustrates the processors and the memories as being within the computing devices, components described herein may include multiple processors and memories that can operate in different physical locations and not within the same computing device. For example, some of the instructions and the data may be stored on a removable SD card and others within a read-only computer chip. Some or all of the instructions and data may be stored in a location physically remote from, yet still accessible by, the processors. Similarly, the processors may include a collection of processors that may perform concurrent and/or sequential operation. The computing devices may each include one or more internal clocks providing timing information, which may be used for time measurement for operations and programs run by the computing devices.

Server computing device 110 may be connected over network 130 to data center 140 housing any number of hardware accelerators. Data center 140 may be one of multiple data centers or other facilities in which various types of computing devices, such as hardware accelerators, are located. Computing resources housed in the data center may be specified for orchestrating the parallel rollout of independent aspects of production assets, as described herein.

Data center 140 may include a plurality of hardware accelerators, such as hardware accelerators 160A-N. Hardware accelerators 160A-N can be any type of processor, such as a GPU, FPGA, or ASIC. Aspects of the disclosure may in some examples be implemented as specialized features of general-purpose processors, e.g., as part of a CPU or other processor configured to orchestrate the parallel rollout of independent aspects of production assets, as described herein.

Server computing device 110, user computing device 120, and data center 140 may be capable of direct and indirect communication over the network. For example, using a network socket, user computing device 120 may connect to a service operating on server computing device 110 through an Internet protocol. In some instances, user computing device 120 may connect to a service operating within data center 140. The devices and data center 140 may set up listening sockets that may accept an initiating connection for sending and receiving information, such as user update requests and notifications indicating completion of updates deployed to implement the requested updates. The network itself may include various configurations and protocols including the Internet, World Wide Web, intranets, virtual private networks, wide area networks, local networks, and private networks using communication protocols proprietary to one or more companies. The network may support a variety of short- and long-range connections. The short- and long-range connections may be made over different bandwidths, such as 2.402 GHz to 2.480 GHz, commonly associated with the Bluetooth® standard, 2.4 GHz and 5 GHz, commonly associated with the Wi-Fi® communication protocol; or with a variety of communication standards, such as the LTE® standard for wireless broadband communication. The network may also support wired connections between the devices and the data center, including over various types of Ethernet connection.

Although a single server computing device, user computing device, and data center are shown in FIG. 11, it is understood that the aspects of the disclosure may be implemented according to a variety of different configurations and quantities of computing devices, including in paradigms for sequential or parallel processing, or over a distributed network of multiple devices. In some implementations, aspects of the disclosure may be performed on a single device connected to hardware accelerators configured to optimize the orchestration of parallel rollouts of independent aspects of production assets, and any combination thereof.

The aspect aware deployment method described herein may utilize late binding. As such, the described method for orchestrating the parallel rollout of independent aspects of production assets might not set versions and/or depend on product specification incarnations. Instead, aspect updates may be handled independently, spontaneously, and in parallel without interrupting concurrently running updates pertaining to a common asset. Therefore, different processes modifying different aspects for the same asset may execute a gradual rollout independently and without interference. Through the described method, the meaning of HEAD of an intended aspect state for a “config as code” setup may change from a last committed change in a code repository to a last set of committed changes as tracked the aspect store.

Aspects of this disclosure can be implemented in digital electronic circuitry, in tangibly-embodied computer software or firmware, and/or in computer hardware, such as the structure disclosed herein, their structural equivalents, or combinations thereof. Aspects of this disclosure can further be implemented as one or more computer programs, such as one or more modules of computer program instructions encoded on a tangible non-transitory computer storage medium for execution by, or to control the operation of, one or more data processing apparatus. The computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, that is generated to encode information for transmission to suitable receiver apparatus for execution by a data processing apparatus.

The term “configured” is used herein in connection with systems and computer program components. For a system of one or more computers to be configured to perform particular operations or actions means that the system has installed on it software, firmware, hardware, or a combination thereof that cause the system to perform the operations or actions. For one or more computer programs to be configured to perform particular operations or actions means that the one or more programs include instructions that, when executed by one or more data processing apparatus, cause the apparatus to perform the operations or actions.

The term “data processing apparatus” refers to data processing hardware and encompasses various apparatus, devices, and machines for processing data, including programmable processors, a computer, or combinations thereof. The data processing apparatus can include special purpose logic circuitry, such as a field programmable gate array (FPGA) or an application specific integrated circuit (ASIC). The data processing apparatus can include code that creates an execution environment for computer programs, such as code that constitutes processor firmware, a protocol stack, a database management system, an operating system, or combinations thereof.

The data processing apparatus can include special-purpose hardware accelerator units for implementing machine learning models to process common and compute-intensive parts of machine learning training or production, such as inference or workloads. Machine learning models can be implemented and deployed using one or more machine learning frameworks, such as a TensorFlow framework.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a standalone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner. The data can be stored on one or more storage devices in one or more locations. For example, an index database can include multiple collections of data, each of which may be organized and accessed differently.

The term “engine” refers to a software-based system, subsystem, or process that is programmed to perform one or more specific functions. The engine can be implemented as one or more software modules or components, or can be installed on one or more computers in one or more locations. A particular engine can have one or more computers dedicated thereto, or multiple engines can be installed and running on the same computer or computers.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers.

A computer or special purpose logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, a personal digital assistant (PDA), a mobile audio or video player, a game console, a Global Positioning System (GPS), or a portable storage device, e.g., a universal serial bus (USB) flash drive, as examples.

Computer readable media suitable for storing the one or more computer programs can include any form of volatile or non-volatile memory, media, or memory devices. Examples include semiconductor memory devices. e.g., EPROM, EEPROM, or flash memory devices, magnetic disks, e.g., internal hard disks or removable disks, magneto optical disks, CD-ROM disks, DVD-ROM disks, or combinations thereof.

Aspects of the disclosure can be implemented in a computing system that includes a back-end component, e.g., as a data server, a middleware component, e.g., an application server, or a front end component, e.g., a client computer having a graphical user interface, a web browser, or an app, or any combination thereof. The components of the system can be interconnected by any form or medium of digital data communication, such as a communication network. Examples of communication networks include a local area network (LAN) and a wide area network (WAN). e.g., the Internet.

The computing system can include clients and servers. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

Unless otherwise stated, the foregoing examples are not mutually exclusive, but may be implemented in various combinations to achieve unique advantages. As these and other variations and combinations of the features discussed above can be utilized without departing from the subject matter defined by the claims, the foregoing description should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A system for orchestrating a rollout of independent aspect updates, the system comprising:
one or more application programming interfaces (APIs);
one or more computing devices configured to communicate with the one or more APIs; and
instructions that, when executed, cause the one or more APIs to:
receive, from the one or more computing devices, one or more updates to be deployed for execution, wherein an update indicates an asset, an aspect to be updated, and a new value for the aspect;
select, from an aspect store storing the received one or more updates to be deployed for execution, one or more updates to be executed;
assign a unique change identifier to the one or more updates;
update, based on the unique change identifier, a state field associated with the one or more updates;
execute, in a system backend and based on the state field, the one or more updates;
update, based on the execution, the state field associated with the one or more updates; and
modify records within the aspect store based on executing the one or more updates.

2. The system of claim 1, wherein the asset corresponds to an entity in production that is associated with an enforceable state.

3. The system of claim 2, wherein the aspect to be updated corresponds to a single property of the asset.

4. The system of claim 3, wherein an aspect update indicates the new value of the aspect,
wherein the new value of the aspect corresponds to an intended value of the aspect,
wherein the intended value of the aspect is different from a baseline intent value of the aspect, and
wherein the baseline intent value of the aspect indicates a most recent value or state of the aspect.

5. The system of claim 1, wherein the aspect store comprises the records, and wherein the records indicate:
a unique asset identifier associated with the asset;
an indication of the aspect to be updated, wherein the aspect is associated with the asset;
a baseline intent value of the aspect;
the state field associated with the one or more updates; and
a unique rollout identifier indicating an order in which the one or more updates should be deployed.

6. The system of claim 5, wherein the state field indicates one of a pending update or a committed update,
wherein a pending update state field indicates that the aspect update associated with the one or more updates has not been deployed; and
wherein a committed update state field indicates that the aspect update associated with the one or more updates was deployed.

7. The system of claim 6, wherein the updating, based on the unique change identifier, the state field associated with the one or more updates further causes the one or more APIs to label the one or more updates to be executed as pending.

8. The system of claim 1, wherein the executing the one or more updates further causes the one or more APIs to:
update a database storing information that describes:
a current state of a system infrastructure of the system running the asset and the aspect, and
a current production landscape of an updated system infrastructure; and
bind an incarnation of the database with the aspect to be updated.

9. The system of claim 8, wherein binding the incarnation of the database with the aspect to be updated further causes the one or more APIs to:
determine an intended state of the aspect to be reached based on execution of an update; and
patch the intended state of the aspect to a baseline intent value of the aspect.

10. The system of claim 1, wherein the updating, based on the executing, the state field further causes the one or more APIs to label values associated with aspects indicated in the one or more updates as committed.

11. The system of claim 1, wherein modifying the records within the aspect store based on the execution the one or more updates further causes the one or more APIs to:
terminate tracking of the unique change identifier associated with the one or more updates;
update an aspect value from a baseline intent value to the new value for the aspect; and
remove a unique rollout identifier associated with the one or more updates.

12. A method of orchestrating a rollout of independent aspect updates, the method comprising:
receiving, by one or more application programming interfaces (APIs) and from one or more computing devices, one or more updates to be deployed for execution, wherein an update indicates an asset, an aspect to be updated, and an aspect update;
selecting, by the one or more APIs and from an aspect store storing the received one or more updates to be deployed for execution, one or more updates to be executed;
assigning, by the one or more APIs, a unique change identifier to the one or more updates;
updating, by the one or more APIs and based on the unique change identifier, a state field associated with the one or more updates;
executing, by the one or more APIs and in a system backend and based on the state field, the one or more updates;
updating, by the one or more APIs and based on the executing, the state field associated with the one or more updates; and
modifying, by the one or more APIs, records within the aspect store based on executing the one or more updates.

13. The method of claim 12, wherein the aspect store comprises the records, and wherein the records indicate:
a unique asset identifier associated with the asset;
an indication of the aspect to be updated, wherein the aspect is associated with the asset;
a baseline intent value of the aspect;
the state field associated with the one or more updates; and
a unique rollout identifier indicating an order in which the one or more updates should be deployed.

14. The method of claim 13, wherein the state field indicates one of a pending update or a committed update,
wherein a pending update state field indicates that the aspect update associated with the one or more updates has not been deployed; and
wherein a committed update state field indicates that the aspect update associated with the one or more updates was deployed.

15. The method of claim 14, wherein the updating, based on the unique change identifier, the state field associated with the one or more updates further comprises labeling the one or more updates to be executed as pending.

16. The method of claim 12, wherein the executing the one or more updates further comprises:
updating, by the one or more APIs, a database storing information that describes:
a current state of a system infrastructure of the system running the asset and the aspect, and
a current production landscape of an updated system infrastructure; and
binding, by the one or more APIs, an incarnation of the database with the aspect to be updated.

17. The method of claim 16, wherein the binding further comprises:
determining, by the one or more APIs, an intended state of the aspect to be reached based on execution of an update; and
patching, by the one or more APIs, the intended state of the aspect to a baseline intent value of the aspect.

18. A non-transitory computer readable storage medium storing instructions that, when executed by one or more application programming interfaces (APIs) for orchestrating a rollout of independent aspect updates, cause the one or more APIs to:
receive, from one or more computing devices, one or more updates to be deployed for execution, wherein an update indicates an asset, an aspect to be updated, and an aspect update;
select, from an aspect store storing the received one or more updates to be deployed for execution, one or more updates to be executed;
assign a unique change identifier to the one or more updates;
update, based on the unique change identifier, a state field associated with the one or more updates;
execute, in a system backend and based on the state field, the one or more updates;
update, based on the executing, the state field associated with the one or more updates; and
modify records within the aspect store based on executing the one or more updates.

19. The non-transitory computer readable storage medium of claim 18, wherein the executing the one or more updates further causes the one or more APIs to:
update a database storing information that describes:
a current state of a system infrastructure of the system running the asset and the aspect, and
a current production landscape of an updated system infrastructure; and
bind an incarnation of the database with the aspect to be updated.

20. The non-transitory computer readable storage medium of claim 19, wherein binding the incarnation of the database with the aspect to be updated further causes the one or more APIs to:
determine an intended state of the aspect to be reached based on execution of an update: and
patch the intended state of the aspect to a baseline intent value of the aspect.
